(19) United States
(12) Patent Application Publication
(10) Pub. No.: US 2003/0168164 A1
(43) Pub. Date: Sep. 11, 2003

(54) Composite structures

(76) Inventors: Richard Blackmore, Houston, TX (US); Mark T Sloan, Spring, TX (US); William M Lepola, Magnolia, TX (US)

Correspondence Address: Richard C Himelhoch, Wallenstein & Wagner, 53rd Floor, 311 South Wacker Drive, Chicago, IL, 60606-6622, US

(21) Appl. No.: 10/182,968

(22) PCT Filed: Feb. 5, 2001
(86) PCT No.: PCT/US01/40021

(51) Int. Cl. B32B 31/20

(52) U.S. Cl. 156/308.2; 264/31; 156/244.11

(57) ABSTRACT

A composite substrate for a fiber reinforced plastic part comprising a first outer thermoplastic sheet, an intermediate conductive layer or layers, and a second inner thermoplastic sheet. The composite substrate formed by electrically resistively heating the conductive layer or layers to melt the thermoplastic sheets, and applying pressure to consolidate the layers into a rigid substrate. The conductive layer or layers formed of a conductive fiber mat or tape. Additionally, a method is disclosed comprising providing a conductive filament impregnated with a resin; running the conductive filament through an electrical contact, the electrical contact connected to a supply of electric power; and, winding the filament to a mandrel including a second electrical contact connected to said supply of power. Electricity is then induced through the filament from the first contact to the second contact to resistively heat the filament and cure the resin. Additionally, a composite structure and method for curing a concrete object placed on, or in close proximity to the structure. The composite structure comprises an upper section having a fiber architecture impregnated with a resin, where the fiber architecture is formed from a plurality of conductive fibers. A lower section having a portion of insulation material and a portion of heat reflective material, where the insulation material is adapted to insulate the structure, and where the reflective material is adapted to reflect heat from the lower section to the upper section. A plurality of electrical contacts, where the contacts are connected to the conductive fibers in the upper section. A plurality of electric leads connected to the contacts and a power source. The upper section having an outer surface adapted to receive the object, the outer surface having an epoxy coating. The lower section has an outer surface, with an epoxy coating. The upper section further having a portion of high-strength materials adapted to support the concrete object. The fiber architecture further comprises a plurality of non-conductive fibers.

### RELATED CASES

The present invention claims priority from provisional application nos. 60/180,575; 60/179,949 and 60/179,962.

### TECHNICAL FIELD

The present invention relates to reinforced composite parts and a method for forming such parts. More specifically, this invention relates to a composite substrate for molding a fiber reinforced plastic or thermoplastic part and a method for molding a fiber reinforced plastic or thermoplastic composite part.

The present invention also relates to a filament wound composite part and to a method of forming the part. More specifically, the invention relates to a composite part formed from a resin impregnated conductive filament, and to a method of forming the part by electrically resistively heating the filament as it is being wound about a mandrel.

The invention further relates to an apparatus for curing concrete objects. More specifically, the invention relates to a novel composite structure and method for applying heat to a concrete object during the cure cycle to reduce the cure cycle time and increase the strength of the cured concrete object.

### BACKGROUND OF THE INVENTION

A fiber reinforced thermo plastic (hereinafter referred to as an FRTP) composite part can be formed from a combination of multiple layers of materials. Preferably, an inner and outer layer is formed from casting or extruding thermoplastic resin. However, the inner and outer layers can be formed by other conventional means. Moreover, in addition to thermoplastic resin, a thermoset resin or copolymer resin can be utilized to consolidate the layers. It is also common to use a composite resin prepreg as a base material of a FRTP to make a product light in weight and to improve the rigidity of the part.

An FRTP product is typically formed by a hand lay-up method. Fiber mats or composite resin prepregs having solvent resistence and a good affinity to a resin for molding an FRP, are alternately laminated. Alternatively, a compression molding can be employed.

However, these conventional molding methods for an FRP have drawbacks. For example, alternately laminating fiber mats and thermoset resin pregregs, requires much time and labor. Additionally, the bond between the fiber mat and the composite resin prepreg depends solely on the chemical bonding force of the resin. Accordingly, if this bonding force is weak, delamination of the layers is likely to occur. This is typically due to an external force or a difference in expansion or shrinkage of the materials (resulting from hot or cold temperatures) over a long period of time, thus leading to the deterioration of the product.

Other problems are associated with forming objects from concrete. Concrete is a building material used throughout the world due to its low cost, high strength, and durability. Another factor contributing to the widespread use of concrete is the ability to form concrete in a wide variety of geometries and configurations. Concrete is commonly used to form conduits or sewage pipes that are placed underground. Concrete conduits and other structures can be pre-cast at a site remote from an installation point, or they can be cast in-place near the installation point. Regardless of where the concrete is cast, it must undergo a curing process or cycle.

Casting concrete conduits and other structures in-place generally requires the use of reusable concrete forms, which support the concrete during the formation or curing process. When cast in-place, concrete is subject to the environmental conditions of the installation point, which is typically a construction site. Unless it is protected in some manner during the curing cycle, the concrete is subjected to environmental conditions, which include rain, low temperatures, high temperatures, and humidity. These environmental conditions can negatively affect the cure cycle time, the strength of the concrete during the curing cycle, and strength of the concrete after the cure cycle is completed.

Of particular concern is the inverse relationship between curing cycle time and temperature. Generally, the lower the temperature, the longer the cure cycle time. At very low temperatures, the water in the un-cured concrete may freeze. This is a dangerous condition because frozen water can cause heaving of the partially set/un-cured concrete and its surrounding forms.

While the heating of concrete structures during the cure cycle can be required when there are extremely low ambient temperatures, heating can be employed in warmer temperatures. Heating the concrete structures in warmer temperatures can accelerate the strength gain of the concrete during the curing cycle. The strength gain and the curing cycle time are the primary factors which affect the turn-around time of the concrete forming apparatus. Only when the concrete has reached a sufficient strength and state of cure may the forms be stripped from the curing concrete for use elsewhere. Turn-around time is of particular concern in civil engineering projects, such as bridges or walkways, where the structure will be closed to use during construction.

In an effort to reduce the cure cycle time, un-cured concrete structures have been heated with less than stellar results. Conventional methods of heating concrete during the curing cycle involve placing the concrete structure in a temporary structure that is heated with portable heaters. The temporary structure is usually constructed from scrap frame lumber, and is poorly insulated with a sheet material such as polyethylene. As a result, a large amount, up to 95 percent, of the heat generated by the portable heaters escapes from the temporary structure. Consequently, the cure cycle is not shortened in appreciable amount. Also, there is a generally unequal distribution of heat in these structures because the majority of generated heat remains near the heaters. In addition, the construction of these temporary structures consumes a high amount of labor. The high cost of labor and materials precludes the construction of better quality structures. Accordingly, the conventional methods of reducing the cure cycle time are plagued with these and other defects.

Even if the temporary structures could be built in a manner that remedies the defects outlined above, the curing cycle would stiffer from a basic principle of thermodynamics—heat rises. Because heat always rises from a lower level to a higher level, the lower portion of the concrete conduit or structure positioned in the temporary structure will not be exposed to a sufficient quantity of heat to complete the cure cycle. As a result, the lower portion of the conduit or structure will fracture and crack when the conduit or structure is moved a measurable distance. In the rare situations where the crack is minor, the concrete can be repaired. However, in the more common situation, the crack is significant and the conduit or structure must be destroyed. The destruction of the conduit or structure increases production costs and negatively affects efficiency and material costs.

### SUMMARY OF THE INVENTION

In one embodiment of the invention, a fiber reinforced thermoplastic (“FRTP”) composite part can be formed from the combination of multiple layers. Preferably, a first or inner layer, and second or outer layer are formed from the casting or extrusion of thermoplastic resin; however, the inner and outer layers can be formed from other conventional means. The invention further includes a intermediate layer or layers formed from conductive fibers or from conductive tape. The conductive fibers and tape can be either ferrous or non-ferrous. The combined layers are either heat formed or thermo-compression consolidated into a hybrid composite structure.

To mold the FRP composite part, an electric current is applied to the intermediate layer or layers of fibers or tape to resistively heat the thermoplastic resin in the inner and outer layer. There must be sufficient current applied to exceed the melt temperature of the thermoplastic resin so that the resin will flow. Pressure is then applied to form the finished part. The applied pressure can be in the form of air or liquid. Additionally, the intermediate layer may include thermoplastic filaments consolidated with the conductive fibers. These filaments will also melt as the conductive fibers are resistively heated and enhance the consolidation of the outer and inner layers with the intermediate layer.

The use of heated molds to cure the resin is not required by this method; however, a mold can be used to hold or position the part to facilitate the application of electric current. In addition, the electrical contacts can be positioned within the mold, such that they come in direct contact with the conductive elements in the FRTP part. The mold can be heated resistively also.

In addition to containing conductive fibers or conductive tape, the intermediate layer could include a thermosetting resin. This feature can result in a more rigid, unified structure.

In another embodiment, the invention is a method of forming a composite part by winding a conductive filament about a mandrel. The method comprises providing a conductive filament impregnated with a resin; running the conductive filament through an electrical contact, the electrical contact connected to a supply of electric power; and, winding the filament to a mandrel including a second electrical contact connected to said supply of power. Electricity is then induced through the filament from the first contact to the second contact to resistively heat the filament and cure the resin. In an alternative embodiment, a bear conductive filament can be run through a resin bath just prior to being wound on the mandrel.

Another embodiment of the invention is a composite structure for curing a concrete object placed on the structure. The composite structure comprises an upper section having a fiber architecture impregnated with a resin, the fiber architecture formed from a plurality of conductive fibers. A lower section having a portion of insulation material and a portion of heat reflective material. The insulation material adapted to insulate the structure. The reflective material adapted to reflect heat from the lower section to the upper section. A plurality of electrical contacts connected to the conductive fibers in the upper section. A plurality of electric leads connected to the contacts and a power source.

The composite structure further comprising an outer surface on the upper section having an epoxy coating. The outer surface adapted to receive the concrete object. The lower section has an outer surface with an epoxy coating. The upper section has a portion of high-strength materials adapted to support the concrete object and increase the structural strength of the composite structure.

Another aspect of the invention is a method for curing a concrete object. The method comprises the following steps: providing a composite structure having an upper section with an upper surface and a fiber architecture formed from a plurality of conductive fibers, and a lower section having insulation material and heat reflective material; positioning an un-cured concrete object on the upper surface such that a lower portion of the concrete object is in contact with the upper surface; applying current to the conductive fibers in the upper section to resistively heat the conductive fiber and cure the lower portion of the concrete object.

The method further comprises the step of connecting electric leads to a power source and the conductive fibers in the upper section. A further step involves applying additional current to the conductive fibers in the upper section to resistively heat the conductive fibers and cure an upper portion of the concrete object.

Further aspects of the invention are disclosed in the detailed description of the preferred embodiment, the drawings and the claims.

### BRIEF DESCRIPTION OF THE DRAWINGS

Embodiments of the invention will be described with the aid of the following diagrammatic drawings.

FIG. 1 is a cross-sectional exploded view of a substrate in a mold;

FIG. 2 is a cross-sectional view of the substrate of FIG. 1 with the mold closed;

FIG. 3 is a perspective view of an open mold that may hold a composite substrate of the present invention;

FIG. 4 is a cross-sectional exploded view of a substrate in an open mold;

FIG. 5 is a cross-sectional view of the open mold of FIG. 4 with the vacuum sealing the substrate against the open mold;

FIG. 6 is an exploded cross-sectional view of a fiber reinforced thermoplastic part of the present invention;

FIG. 7 is alternative embodiment of the part of FIG. 6, including a thermoset resin combined with the conductive layer;

FIG. 8 is a graphical illustration of a filament winding operation in accordance with the present invention;

FIG. 9 is a graphical illustration of another embodiment of a filament winding operation in accordance with the present invention;

FIG. 10 is a perspective view of a composite structure according to the invention;

FIG. 11 is a side view of the composite structure of FIG. 10, showing a plurality of conduits positioned on the composite structure;

FIG. 12 is a partial side view of the composite structure of FIG. 10, showing a cutaway of a portion of the composite structure; and,

FIG. 13 is a partial side view of the composite structure of FIG. 10, showing an upper and lower sections, and a plurality of features therein.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Thermoplastic Composite Part

The present invention provides a reinforcing substrate for reinforcement of a plastic part. The substrate is a hybrid of a thermoplastic resin (preferably in the form of a sheet) and conductive and reinforcing fibers.

A thermoplastic resin typically is stored in the form of plastic pellets. These pellets can be subjected to forming process to create different structures.. For example, the pellets may be melted and then extruded, blow molded, or compression molded. In this manner, the thermoplastic resin can be formed into a thin sheet or other useful configurations. Moreover, thermoplastic resins can be maintained indefinitely, and can be formed and reformed. In contrast, thermoset resins are typically in liquid form and have definite shelf lives. That is, after a certain amount of time (depending on the particular chemistry of the thermoset resin, the molecules of the resin cross-link and harden—heat can also initiate this process prematurely).

A FRTP (fiber reinforced thermoplastic) composite part of the present invention can be formed from the combination of multiple layers. Preferably an inner layer and an outer layer are formed from casting or extruding of thermoplastic resin into a sheet. An intermediate layer (or multiple intermediate layers) is formed from electrically conductive fibers (preferably in the form of a fiber mat) or electrically conductive fabric tape.

The inner, outer and intermediate layers are combined to form a hybrid composite structure. This is accomplished by applying pressure to the layers while heating the conductive fibers of the intermediate layer(s). Specifically, an electric current is applied to the intermediate layer or layers to resistively heat the conductive fibers or tape, and subsequently heat the thermoplastic resin in the inner and outer layers. Sufficient current should be applied to exceed the melt temperature of the resin so that the resin will flow into the fibers or tape to form a mechanical link between the layers and thus integrally consolidate the layers.

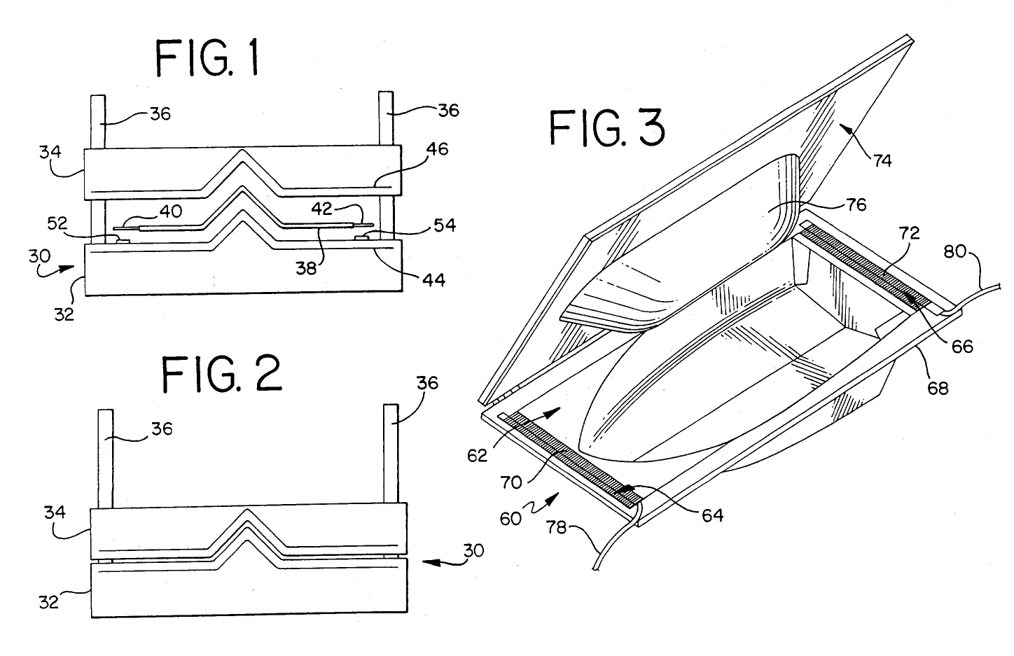

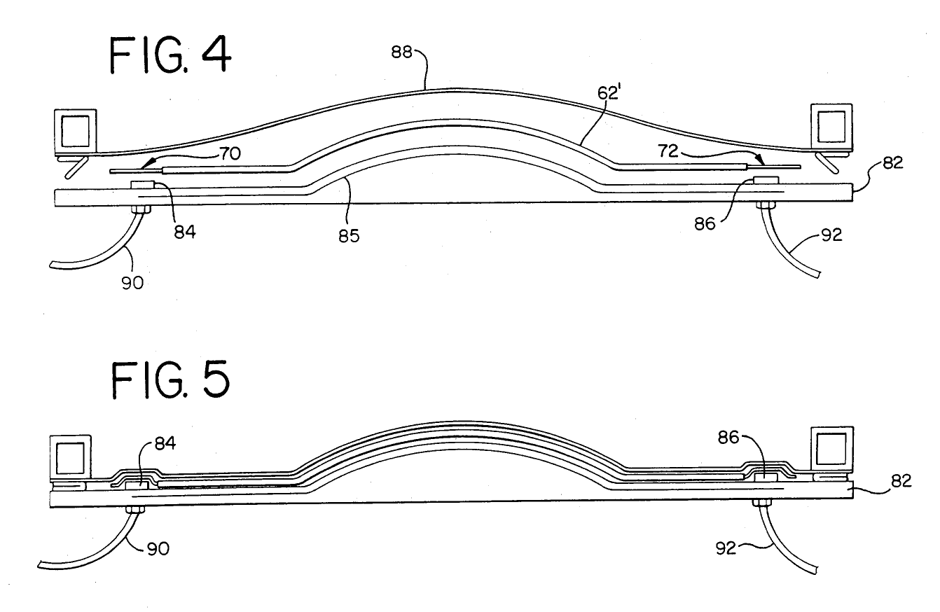

Pressure is then applied to the layers to form a finished part or substrate. The applied pressure can be in the form of air or liquid. Because the conductive fibers or tape of the intermediate layer(s) is utilized to heat the substrate, a heated mold is not essential to forming the substrate and a FRTP part can be made at a much lower cost than typical of parts requiring large molds to heat the thermoplastic resin. However, a mold (such as those disclosed in U.S. Pat. No. 5,656,231, and shown here as FIGS. 1-5) can be used to hold or position the layers to facilitate application of electric current (however, the material placed in such molds is that disclosed in the present application as apposed to the material disclosed in the '231 patent). Such molds may include electric contacts positioned to come into apparent intimate contact with the conductive fibers or tape of the intermediate layer(s). A portion of the intermediate layer(s) may be exposed to assist in providing such contact.

In addition to containing conductive fibers or tape, the intermediate layer or layers may include a thermoset resin impregnated in the conductive fibers, or thermoplastic filaments consolidated with the conductive fibers. Use of thermoplastic filaments can result in a more rigid, unified part. This is because thermoplastic filaments in the hybrid fabric will act as a tie-ply between the various layers. Moreover, other fibers, such as fiberglass fibers, can be mechanically consolidated with the thermoplastic filaments and conductive fibers to form the intermediate layer.

In embodiments of the invention utilizing a conductive fiber mat as an intermediate layer, the mat may, for example, be a surfacing mat, a non-woven mat, a continuous strand mat or a woven mat. Additionally, the fibers may be chemically bonded to a thermoplastic sheet by means of a resin powder or a resin emulsion, in addition to being mechanically bound to a sheet by means of resistively heating the intermediate layer to melt the sheet. Further, in order to increase the bonding properties, an adhesive may be disposed between the fiber mat and the thermoplastic sheet. This bonding can be the tie-ply referred to above.

The fibers or tape of the intermediate layer(s) may include inorganic fibers such as glass fibers, mineral fibers, ceramic fibers or carbon fibers. The fibers or tape may also include organic fibers such as polyester fibers.

Preferably, the composite substrate for plastic reinforcement is a conductive fiber mat and a thermoplastic sheet integrated by resistive heating of the conductive fibers in the mat. When this composite substrate is used for molding FRTP parts, it is possible to obtain parts in much shorter time than typical. This is because the conductive fiber or tape, which become part of the finished product, is in intimate contact with the thermoplastic sheet and thus efficiently heats the plastic to a sufficient melt temperature.

A thermoplastic resin used for the formation of the FRTP product may be polyethylene. PVC, PVC alloys and other urethanes may be used as well.

As set forth above, in addition to the thermoplastic resin, a typical liquid thermoset resin can be used in combination with the thermoplastic sheets and conductive layers for the formation of the FRTP product or part. Preferably, the thermosetting resin may be an unsaturated polyester resin, a vinyl ester resin, a phenol resin, a methyl methacrylate resin, an epoxy resin, a dicyclopentadiene resin or a furan resin. Among these resins, an unsaturated polyester resin is particularly preferred from the view point of ease of impregnation and moldability. Additionally, the densities of such resins may be varied as appropriate for a particular part.

The FRTP of the present invention is a composite substrate for plastic reinforcement. The composite substrate includes a conductive fiber mat or tape and a thermoplastic sheet that is integrally combined with the conductive fiber mat or tape by resistive heating of the conductive fibers or tape. In this manner, the thermoplastic resin in the thermoplastic sheet flows to form a mechanical bond with the conductive fiber mat or tape, thus anchoring the sheets to the fibers or tape. A liquid thermosetting resin may also be applied to the conductive fibers or tape. The conductive fibers or tape provide a reinforcing structure to the FRTP part.

In addition, because a conductive fiber mat or tape is used in the composite substrate, it is possible to obtain a FRTP product having a superior level of rigidity as conventional products while being thinner than such products. Additionally, by changing the amount of fiber in the mat, a part of the thermoplastic sheet may optionally be adjusted to obtain an FRTP product having optimal rigidity for a particular purpose.

The FRP product formed in the manner discussed utilizing the composite substrate has improved compression strength. Additionally, delamination of the conductive fiber mat or tape and the thermoplastic sheets hardly occurs because of the mechanical bonding of the layers.

In one embodiment, the thermoplastic sheets can be consolidated with a woven, stitched, or knitted fabric of proportionately distributed bundles or filaments of glass and thermoplastic (polyester, urethane, polyethylene, polypropylene, or nylon). Alternatively the thermoplastic sheets can be consolidated with a woven, stitched, or knitted fabric of proportionately distributed bundles or filaments of carbon and thermoplastic, or a combination of glass and plastic and carbon and plastic.

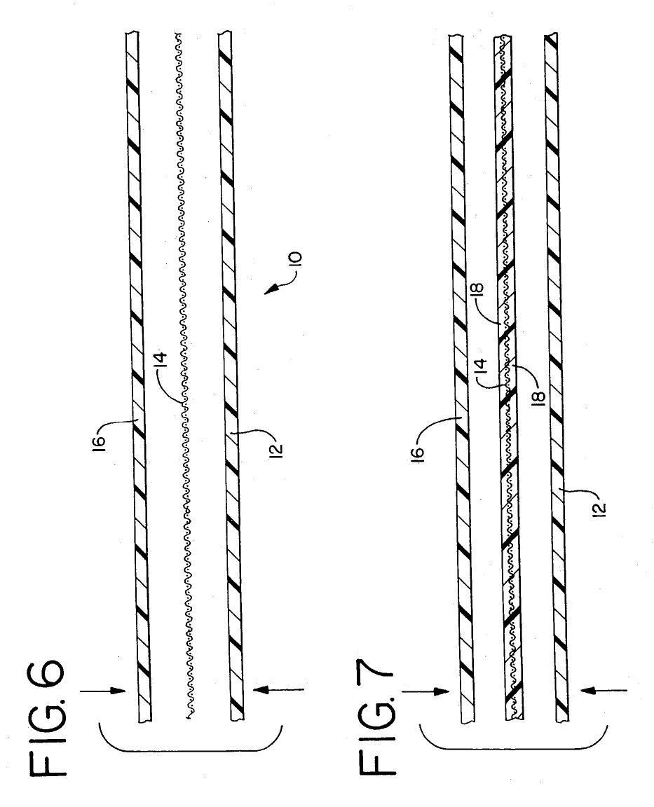

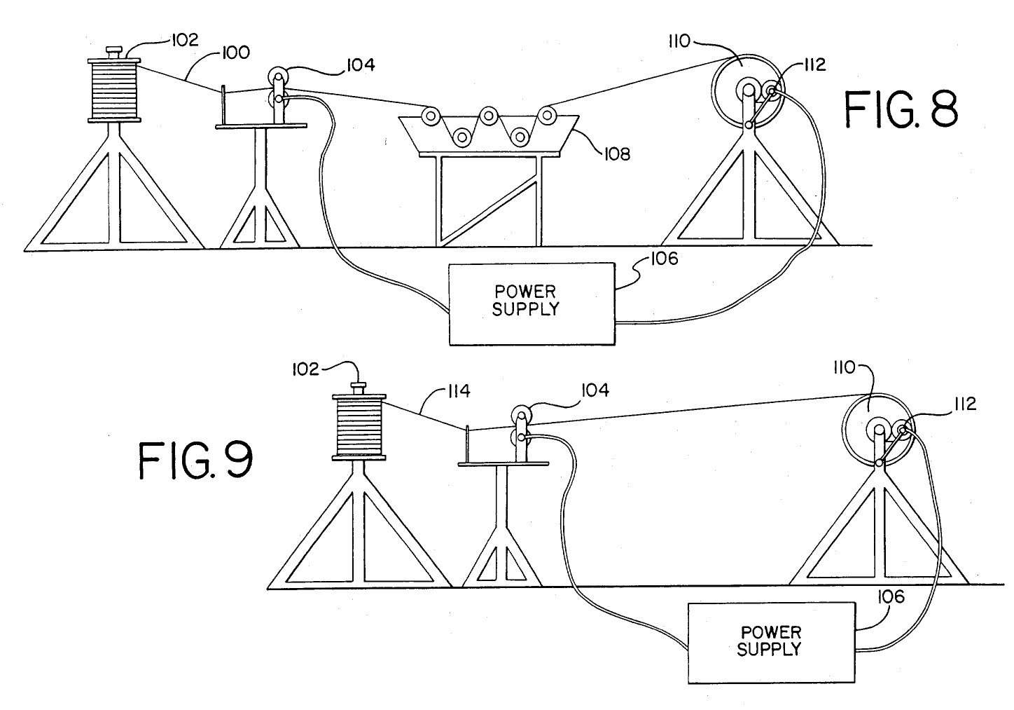

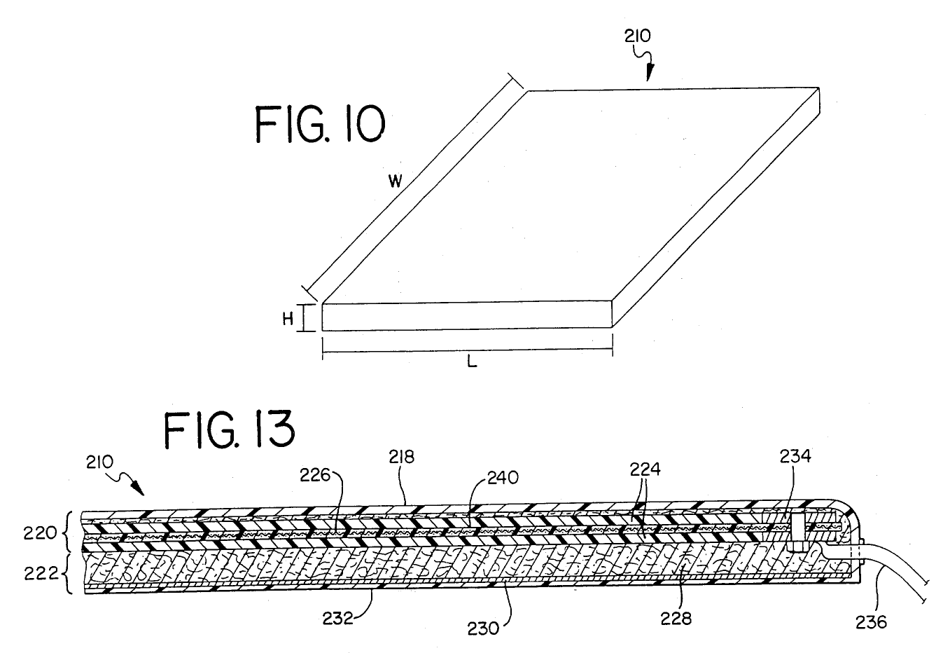

As shown in a cross-section exploded view in FIG. 6, the composite structure 10 includes a first thermoplastic sheet 12, an intermediate conductive layer 14 and a second thermoplastic sheet 16. Pressure is applied to compress the thermoplastic sheets 12 and 16, and intermediate layer 14 together. The conductive layer is electrically resistively heated to melt the thermoplastic layers 12 and 16 sufficiently so that at least part of each sheet flows into the conductive layer to mechanically bond or link the sheets and conductive layer into a monolithic structure. FIG. 7 shows an alternative embodiment including a thermosetting resin 18 in the conductive layer.

Filament Wound Composite Part

Fibers or tapes are applied, under controlled tension, to a rotating, near net shape mandrel. These fibers or tapes are traditionally impregnated with a resin matrix in line, just prior to the application to the mandrel. Where thermosetting resins are used, heat is generally required to complete the cure of the part. This has been accomplished using various, external heat sources (i.e. IR lamps, heated mandrels, forced air, ovens); this process requires considerable capital equipment and is time consuming. Much of the heat energy is lost to the atmosphere. Curing thick composite parts using external heat sources has also proven difficult and even impractical in some situations. Where thermoplastic resins are used in forming filament wound parts, heat in also necessary to bring the TP resin to a melt temperature in order to ensure consolidation. External heating methods are employed here also with the same limitations.

The subject of this invention relates to resistively heating by applying an electrical current to conductive fibers and tapes, which are used in the formation of a filament wound part. The conductive fibers and tapes can be either ferrous or non-ferrous depending upon the process requirements. Rotating electrical contacts are positioned to be in intimate contact with the conductive fibers or tapes at one location on the mandrel and at an opposing location, which completes the electrical circuit. This allows for continuous application of heat throughout the winding process and/or will provide an efficient heat source internal to the part being formed, to complete a cure. Subsequent layers of reinforcing materials can also form an insulation layer therefor eliminating heat loss to the atmosphere. The nonferrous, electrical conductive fibers and tapes can also be designed to provide some, if not all, of the necessary structural reinforcement. Significant energy savings, as well as time, can be anticipated by using this method. Curing composite parts by this method ensures a high degree of cure.

Specific to thermoplastic resins, this method can efficiently be utilized to produce uniform, controllable melt temperatures needed for consolidating the reinforcing materials and the thermoplastic matrix. Here, rotating electrical contacts can be positioned in intimate contact with the nonferrous, electrically conductive reinforcing fibers or tapes in two locations prior to the mandrel. As the impregnated fibers and tapes continuously pass through the contact area, current, sufficient to bring the thermoplastic resin to an ideal melt/flow temperature, is applied. This contact area can be adjusted, along with the rate of speed that the fibers or tapes travel through this area, to ensure adequate melt and flow of the TP resin matrix. Varying the amount of current applied will also control the exact temperature.

The disclosed methods can be controlled electronically by using non-contact temperature sensors to measure temperatures produced. These sensors can provide feedback to the power supply used and regulate the electrical output accordingly. Voltage requirements are linear, therefore an amperage controllable power supply is disclosed where a desired amperage is set, and the required voltage adjusts as the length of the conductive, non-ferrous fiber or tape, increases throughout the winding process.

As shown in FIG. 1, a conductive filament 100 from a spool 102 is passed through a first rotating electrical contact 104. The electrical contact 104 is connected via a line to one terminal of a electric power supply 106.

The conductive filament is then run through a resin impregnation bath 108. The resin impregnated filament is then wound onto a rotating mandrel 110. The rotating mandrel 110 includes a second rotating electrical contact 112 which is connected by a line to another terminal of the power supply 106. In this manner, a complete circuit is created, allowing an electric current to pass through the conductive filament 100. This resistively heats the filament 100 to cure the resin.

In an alternative embodiment disclosed in FIG. 2, the spool 102 includes a filament 104 pre-impregnated with a resin. In this embodiment it is not necessary to run the filament through a resin bath between the first rotating electrical contact and the mandrel.

Cured Concrete Objects

FIG. 10 shows a composite structure 210 for curing a concrete object, or a plurality of concrete objects. In FIG. 10, the objects are concrete conduits 212. The structure 210 has the following dimensions: a length, L, a width, W, and a height, H. The dimensions of the structure 210 are such that the structure can support a single, large object or a plurality of smaller objects.

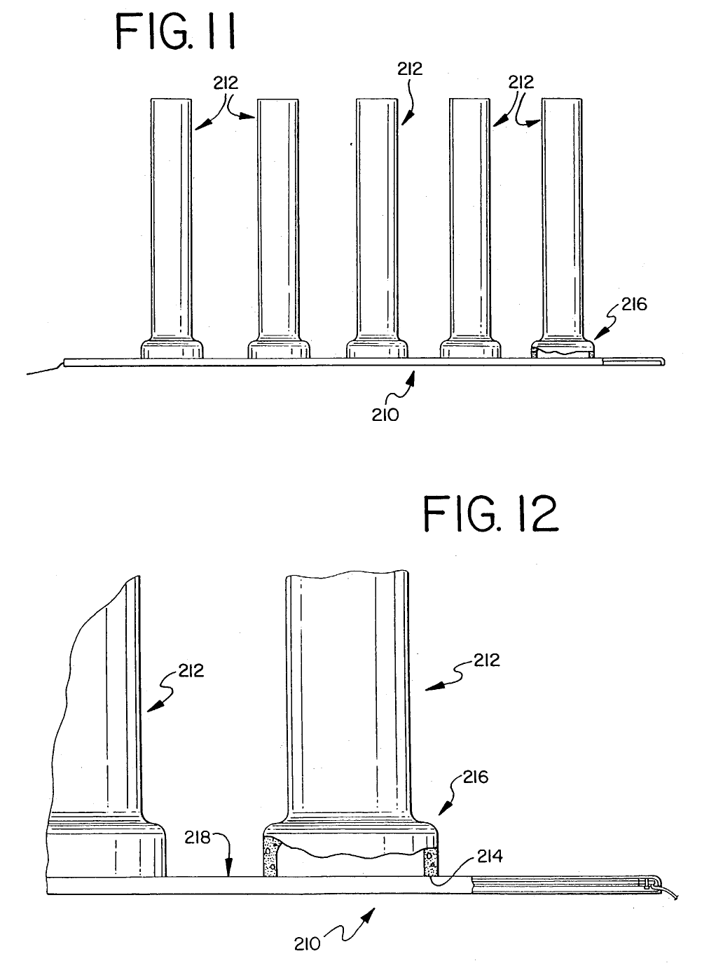

As shown in FIGS. 11 and 12, the conduit 212 is placed on the structure 210, where the lower surface 214 of a lower portion 216 of the conduit 212 is in contact with an outer surface 218 of the structure 210. The lower portion 216 of the conduit 212 is commonly referred to as the “bell portion”

Referring to FIG. 13, the composite structure 210 includes an upper section 220 and a lower section 222. The upper section 220 has a fiber architecture 244 that is formed from a plurality of commingled conductive fibers 226 impregnated with a resin. Preferably, the conductive fibers 226 are carbon fibers because of their high strength. The resin should have high strength and high temperature characteristics to withstand the harsh operating environment that is consistent with conduit formation and construction. The resin can be thermoplastic, thermosetting, fluorocarbon, or fluorosilicone resin.

A number of different mechanical consolidation techniques can be used loosely combine the conductive fibers 226 and form the fiber architecture 224. These consolidation techniques include weaving, braiding, knitting, needling (needle punching), or stitch-bonding. In addition to the mechanical consolidation, the fiber architecture 224 can be formed by chemically consolidating the fibers 226 under vacuum pressure. Regardless of the consolidation technique, the resulting fiber architecture 224 should be an open weave, or loose weave.

Alternatively, the fiber architecture can include a plurality of non-conductive fibers. Similar mechanical consolidation techniques can be used to combine the conductive fibers 226 and non-conductive fibers to form the fiber architecture. The non-conductive fibers can be synthetic fibers, such as polyester, polyethylene, nylon, or fiberglass. Glass fibers can be also be used in combination with carbon and polyester fibers.

The upper section 220 can include a portion of high strength and low mass reinforcement material 240. The reinforcement material 240 increases the strength of the composite structure 210 without disproportionately increasing the thickness or size of the upper section 220 and resulting composite structure 210. Also, the reinforcement material 240 increases the durability of the composite structure 210. Preferably, the reinforcement material 240 is located between the fiber architecture 224 and the upper surface 218 in the upper section 220. Because the reinforcement material 240 is located above the fiber architecture 224 formed from conductive fibers 226, the reinforcement material 240 has a relatively high thermal conductivity value, k, to facilitate heat transfer from the conductive fibers 226 through the upper section 220 and to the conduit 212. The reinforcement material 240 can be composed of glass fibers, carbon fibers, polyester fibers, or a mixture of these fibers.

The lower section 222 has insulation material 228 and heat reflective material 230. The insulation material 228 is adapted to insulate the structure210 to prevent heat loss or flux from the structure 210. Preferably, the insulation material 228 is located above the reflective material 230 in the lower section 222. The insulation material 228 can be a synthetic material such as fiberglass. The reflective material 230 is a high-strength material that reflects heat upwards from the bottom surface 232 of the lower section 222 to the upper section 220 of the structure 210.

The outer surface 218 of the upper section 220 can be coated with an epoxy coating. Similarly, the bottom surface 232 of the lower section 22 can have an epoxy coating. This type of coating protects the surfaces 218, 232 and the structure 210 from the corrosive effects of the harsh environment.

The upper section 220 further includes electrical contacts 234. The contacts 234 are connected to the conductive fibers 226 in the upper section 220. Electric leads 236 are connected to the contacts 234 and a power source. The power source generates electric current that flows through the leads 236 and contacts 234 to resistively heat the conductive fibers 226. Specifically, current travels from the power source through a first lead 236a to a first end of the upper section 220. Current flows from the first end of the upper section 220 to a second end of the upper section 220 through the conductive fibers 226. The current then travels from the second end of the upper section 220 through a second lead 236b to the power source to complete the circuit. Alternatively, the current then travels from the second end of the upper section 220 to the first end of the section 220 through the conductive fibers 226 connected to an alternate second lead 236c. The current then flows through the alternate second lead 236c to the power source to complete the circuit.

The composite structure 210 is formed from the consolidation of multiple components (resin, conductive fibers 226, insulation material 228, reflective material 230, and reinforcement material 240) in the upper and lower sections 220, 222. To consolidate the components in the sections 220, 222, electric current is applied to the conductive fibers 226 to resistively heat form the components into a single, monolithic structure 210. The structure 210 results once the components are fully heat formed and consolidated. Prior to current being applied, the components are positioned or stacked such that they form a multi-component structure. Once the composite structure 210 is formed, the structure 210 can be used to cure concrete conduits that are positioned on the outer surface 218 of the structure 210.

The composite structure 210 is configured to accept and support a wide variety of objects 212. This means that the structure can support a single, large object, such as a conduit header, or a group of smaller objects, such as conduits 212. This attribute greatly increases the versatility and value of the composite structure 210.

In another embodiment, the upper section 220 can have a conductive tape. The conductive tape has a plurality of conductive fibers and a plurality of thermoplastic fibers. The conductive fibers can be located in the inner surface of the tape, or throughout the tape. The conductive tape can be wrapped with a woven, stitch-bonded, or needle-punched tape. The conductive fibers can be commingled carbon fibers. The tape can have a plurality of commingled non-conductive fibers, which can be glass or aramid (kevlar). In addition, the conductive and/or non-conductive fibers can have thermoplastic filaments, in a composition of up to 50 percent. The tape can also include a plurality of commingled synthetic fibers. The synthetic fibers can be polyester fibers, nylon, spectra, polyethylene or polyvinyl chloride. The non-conductive fibers and the synthetic fibers can enhance the bonding between the sections 220, 222 and strengthen the resulting composite structure 210.

The composite structure 210 can be used to cure the bottom portions of virtually any concrete object or conduit, including those used in corrosive environments. Typically, concrete objects and conduits for corrosive environments have a thermo-plastic liner or a cement hybrid-substitute. The composite structure 210 disclosed in this invention can be used with both varieties.

The composite structure 210 can be used in a method for curing a concrete object or plurality of objects that are positioned on the structure 210. The method includes the following steps: providing a composite structure 210 having an upper section 220, the upper section having an upper surface 218, the upper section 220 further having a fiber architecture 224 impregnated with a resin, the fiber architecture 224 formed from a plurality of conductive fibers 226; a lower section 222 having a portion of insulation material 228 and a portion of heat reflective material 232. The un-cured concrete object, i.e. a conduit 212, is positioned on the upper surface 218 such that a lower portion 216 of the conduit 212 is in intimate, or direct contact with the upper surface 218. Current is applied to the conductive fibers 226 in the upper section 220 to resistively heat the conductive fibers 226 and cure the lower portion 216 of the conduit 212.

The method can further include the step of connecting electric leads to a power source and the conductive fibers 226 in the upper section 220. The method can include connecting electrical contacts 234 to the conductive fibers 226 in the upper section 220.

Additional current can be applied to resistively heat the conductive fibers 228 and cure an upper portion of the conduit.212. Described in a different manner, additional current can be applied to resistively heat the conductive fibers 228 and cure the entire object (conduit 212).

Once a sufficient amount of current has been applied to resistively heat the conductive fibers 226 and cure a portion of, or the entire conduit 212, the conduit 212 can be removed from the outer surface 218 of the structure 210. Alternatively, the conduit 212 can be allowed to cool before removing it from the structure 210.

A form can be used in conjunction with the composite structure 210 to support the object during the cure cycle. The form is made from a material with a high thermal conductivity value, k, to facilitate heat transfer from the structure 210 to the object positioned on the structure 210. The form can be positioned above and in direct contact with the outer surface 218 of the composite structure 210. The object, or conduit 212 can be positioned about the form such that an inner surface of the conduit is proximate an outer surface of the form. Described in a different manner, the form is positioned within the conduit such that the outer surface of the form is in intimate contact with the inner surface of the conduit. During the curing process or cycle, the form can support the inner surface of the lower portion 216 of the conduit 212. When the conductive fibers 226 generate heat from being resistively heated, a quantity of the heat can be transferred to the form. A significant portion of the heat transferred to the form can be further transferred to the inner surface of the conduit 212, thereby reducing the cure cycle time of the conduit 212.

The following example illustrates the reduction in cure cycle time and increased strength in the cured object provided by the method of the invention. An experimental concrete object, a concrete wall, was poured and placed on the composite structure 210. The concrete wall had a thickness of 225 mm. A second concrete wall, the control object, was poured with the same dimensions. Both walls were poured from the same batch of concrete at substantially the same time. The first concrete wall was to be cured according to the method described above, and the second concrete wall was to be cured at ambient conditions.

Concrete and ambient air temperature measurements were taken at regular intervals throughout a 24-hour test period and averaged 72 degrees Fahrenheit. In-situ concrete strengths, using the LOK TEST method, were measured at 16, 24 and 48 hours after the initial pouring of the walls. The results are set out in the following Table.

TABLE
Strength (M Pascals) at Various Times after Pouring

| | 16 Hours | 24 Hours | 48 Hours |
|---|---|---|---|
| First wall | 11.3 | 15.3 | 18.4 |
| (experimental) | (45%) | (61%) | (74%) |
| Second wall | 0.0 | 0.0 | 5.0 |
| (control) | | | 2% |

The strength measurements for the first and second wall are provided at three different time periods after the pouring of the walls. The percentages underneath the strength measurements represent the strength at that time period as a percentage of the specified twenty-eight day strength. Although 25 MPA concrete was specified, and this number was used in the percentages in Table 1, 20 liters of water was added per cubic meter of the 25 MPA concrete which would be expected to reduce the MPA to a 28-day strength of 20 to 22 MPA.

While specific embodiments have been illustrated and described, numerous modifications are possible without departing from the spirit of the invention, and the scope of protection is only limited by the scope of the accompanying claims.

We claim:

1. A method for forming a fiber reinforced thermoplastic part, comprising the steps of:
extruding thermoplastic resin to form an first layer;
extruding thermoplastic resin to form a second layer;
introducing a layer of conductive fibers between the first and second layers; and
applying current to the conductive fibers to melt the resin in the first and second layers to form a composite substrate.

2. The method of claim 1 wherein the conductive fibers are non-ferrous.

3. The method of claim 1, wherein the layer of conductive fibers contains a thermosetting resin.

4. The method of claim 1, wherein the layer of conductive fibers is consolidated with thermoplastic filaments.

5. The method of claim 1, wherein the layer of conductive fibers contains a copolymer resin.

6. The method of claim 1, further comprising the step of applying pressure to finalize the shape of the finished part.

7. The method of claim 1, wherein the electrical current is applied by direct contact with the conductive layer.

8. The method of claim 1, wherein the electrical current is induced into the conductive elements by induction.

9. The method of claim 1, wherein the step of introducing the layer of conductive fibers is accomplished by winding the layer.

10. A method of forming a fiber reinforced thermoplastic substrate comprising:
providing a thermoplastic sheet;
providing a layer of conductive fibers;
compressing the thermoplastic sheet against the conductive layer; and
electrically resistively heating the conductive layer to melt the thermoplastic sheet to flow into the fibers of the conductive layer.

11. A composite substrate for a fiber reinforced plastic part comprising a first thermoplastic sheet, and a conductive layer, said first thermoplastic sheet and conductive layer integrally consolidated.

12. The composite substrate of claim 11 further comprising a thermosetting resin in said conductive layer.

13. The composite substrate of claim 11 further comprising an adhesive disposed between said conductive layer and said first thermoplastic sheet.

14. The composite of claim 11 wherein said conductive layer comprises a plurality of conductive fibers and a plurality of thermoplastic filaments.

15. The composite of claim 11 further comprising a second thermoplastic sheet integrally consolidated with said conductive layer and said first thermoplastic sheet..

16. A method for forming composite parts using filament winding utilizing intralaminar heat cure comprising the steps of:
utilizing electrical contacts to provide electrical continuity through electrically conductive fibers impregnated with a thermosetting resin matrix; said electrically conductive fibers used as continuous reinforcement in a filament winding operation; and
applying an electrical current to said electrically conductive continuous fibers during the winding process to heat the thermosetting resin matrix to a temperature below its gel point to reduce viscosity and improve flow.

17. The method of claim 16 wherein said fibers are non-ferrous.

18. A method of forming a composite part comprising the steps of:
providing a conductive filament;
running said conductive filament through an electrical contact, said electrical contact connected to a supply of electric power;
running said filament through a resin bath; and,
winding said filament to a mandrel including a second electrical contact connected to said supply of power.

19. The method of claim 18 further comprising inducing electric current through said conductive filament to cure said resin.

20. The method of claim 18 wherein said conductive filament is a non-ferrous fiber.

21. The method of claim 18 wherein said conductive filament is a tape

22. The method of claim 18 wherein said filament is impregnated with a thermosetting resin.

23. The method of claim 19 comprising applying an electrical current to said electrically conductive filament at the completion of the winding operation to produce heat to cure the thermosetting resin matrix.

24. A method of forming a composite part comprising the steps of:
providing a conductive filament impregnated with a resin;
running said conductive filament through an electrical contact, said electrical contact connected to a supply of electric power; and,
winding said filament to a mandrel including a second electrical contact connected to said supply of power.

25. The method of claim 24 further comprising inducing electric current through said conductive filament to cure said resin.

26. A composite structure for curing a concrete object placed on the structure, the composite structure comprising:
an upper section having a fiber architecture impregnated with a resin, the fiber architecture formed from a plurality of conductive fibers;
a lower section having a portion of insulation material and a portion of heat reflective material, the insulation material adapted to insulate the structure, the reflective material adapted to reflect heat from the lower section to the upper section;
a plurality of electrical contacts, the contacts connected to the conductive fibers in the upper section; and,
a plurality of electric leads, the leads connected to the contacts and a power source.

27. The composite structure of claim 26 wherein the upper section has an outer surface, the outer surface adapted to receive the object, the outer surface having an epoxy coating.

28. The composite structure of claim 26 wherein the lower section has an outer surface, the outer surface having an epoxy coating.

29. The composite structure of claim 26 wherein the upper section has a portion of high-strength materials adapted to support the concrete object.

30. The composite structure of claim 26 wherein the fiber architecture further comprises a plurality of non-conductive fibers.

31. The composite structure of claim 26 wherein the conductive fibers are carbon fibers.

32. A composite structure for curing a concrete conduit positioned on the structure, the structure comprising:
an upper section having a fiber architecture impregnated with a resin, the fiber architecture formed from a plurality of conductive fibers, the upper portion further having a plurality of electrical contacts, the contacts connected to the conductive fibers;
a lower section having a portion of insulation material and heat reflective material, the insulation material positioned above the heat reflective material, the insulation material adapted to insulate the structure, the reflective material adapted to reflect heat from the lower section to the upper section; and,
a plurality of electric leads, the leads connected to the contacts and a power source.

33. The composite structure of claim 32 wherein the upper section has an outer surface, the outer surface adapted to receive the conduit, the outer surface having an epoxy coating.

34. The composite structure of claim 32 wherein the lower section has an outer surface, the outer surface having an epoxy coating.

35. The composite structure of claim 32 wherein the upper section has a portion of high-strength materials adapted to support the concrete conduit.

36. The composite structure of claim 32 wherein the fiber architecture further comprises a plurality of non-conductive fibers.

37. The composite structure of claim 32 wherein the conductive fibers are carbon.

38. The composite structure of claim 32 wherein a form is positioned on the outer surface, the form having a material composition adapted to facilitate heat transfer from the composite structure to the conduit.

39. A method for curing a concrete object comprising the steps of:
providing a composite structure having an upper section, the upper section having an upper surface, the upper section further having a fiber architectureimpregnated with a resin, the fiber architecture formed from a plurality of conductive fibers;
a lower section having a portion of insulation material and a portion of heat reflective material;
positioning an un-cured concrete object on the upper surface such that a lower portion of the concrete object is in contact with the upper surface;
applying current to the conductive fibers in the upper section to resistively heat the conductive fiber and cure the lower portion of the concrete object.

40. The method of claim 39 further comprising the step of connecting electric leads to a power source and the conductive fibers in the upper section.

41. The method of claim 39 further comprising the step of connecting electrical contacts, to the conductive fibers in the upper section.

42. The method of claim 39 further comprising the step of applying additional current to the conductive fibers in the upper section to resistively heat the conductive fibers and cure an upper portion of the concrete object.

43. The method of claim 39 further comprising the step of applying additional current to the conductive fibers in the upper section to resistively heat the conductive fibers and cure the entire concrete object.

44. method for curing a concrete conduit comprising the steps of:
providing a composite structure having an upper section, the upper section having an upper surface, the upper section further having a fiber architecture impregnated with a resin, the fiber architecture formed from a plurality of conductive fibers;
a lower section having a portion of insulation material and a portion of heat reflective material;
positioning a form on the upper surface such that a lower portion of the form is in contact with the upper surface of the composite structure;
positioning an un-cured concrete conduit about the form such that the an inner surface of the conduit is proximate an outer surface of the form, the conduit further positioned such that a lower surface of the conduit is in contact with the upper surface of the composite structure;
applying current to the conductive fibers in the upper section to resistively heat the conductive fiber and cure the lower portion of the concrete object.

45. The method of claim 44 further comprising the step of connecting electric leads to a power source and the conductive fibers in the upper section.

46. The method of claim 45 further comprising the step of applying additional current to the conductive fibers in the upper section to resistively heat the conductive fibers and cure an upper portion of the concrete object.

47. The method of claim 45 further comprising the step of applying additional current to the conductive fibers in the upper section to resistively heat the conductive fibers and cure the entire concrete object.
